(19) United States
(12) Patent Application Publication
(10) Pub. No.: US 2021/0287178 A1
(43) Pub. Date: Sep. 16, 2021

(54) SYSTEM AND METHOD FOR IDENTIFYING SKILLED CANDIDATES VIA SIMULATED PROBLEM SOLVING

(71) Applicant: STATE FARM MUTUAL AUTOMOBILE INSURANCE COMPANY, Bloomington, IL (US)

(72) Inventors: Jackie Makdah, Urbana, IL (US); Umang Chavan, Champaign, IL (US); Aditya Duri, Urbana, IL (US); Terri Lynn Gottleaber, Rockwall, TX (US); Nicholas Simon Charlton, Richardson, TX (US)

(21) Appl. No.: 15/976,020

(22) Filed: May 10, 2018

(51) Int. Cl. G06Q 10/10; G09B 5/00

(52) U.S. Cl. CPC G06Q 10/1053; G09B 5/00

(57) ABSTRACT

Systems and methods for qualifying skilled candidates for an industry position are provided. An interactive challenge component related to a particular industry, including one or more simulated problems to be solved, may be provided to a plurality of participants in the challenge. The simulated problems may be representative of real problems typically solved in the industry. Each participant's performance in the challenge (e.g., number of problems solved correctly, points scored, etc.) may be evaluated in order to identify one or more participants as candidates for an opportunity related to the particular industry. For example, the opportunity may be a career opportunity or an educational opportunity. The qualifying candidates may in turn be provided with information associated with the opportunity. For instance, the qualifying candidates may be provided with information regarding how to apply for the opportunity, or information regarding an interview or a start date for the opportunity.

### FIELD OF DISCLOSURE

In general, the present application is related to ways to qualify skilled candidates for an industry position. In particular, the present application is related to identifying skilled candidates in a particular field or industry by providing simulated problems related to the field or industry to potential candidates.

### BACKGROUND

In some instances, it may be difficult to determine the skill level of a candidate for a position or program using traditional recruiting tools. In particular, for candidates who have short work histories or no work history at all (such as students, or recent graduates), it may be difficult to distinguish the skill level of one candidate from another. Moreover, it may be difficult to reach all potential candidates for a program or a position using traditional job postings alone.

### SUMMARY

In one aspect, a candidate provisioning method for qualifying skilled candidates for an industry position is provided. The candidate provisioning method may execute on one or more processors, and may comprise steps of providing, via a provisioning application (app), an interactive challenge component, the interactive challenge component executing on a client device associated with a candidate, the interactive challenge component causing the client device to simulate one or more problems, the problems requiring interaction by the candidate; determining, via the provisioning app, a performance metric for the candidate, the performance metric based on the interaction by the candidate; and providing, via the provisioning app to the client device, information associated with the industry position, wherein the performance metric for the candidate exceeded a threshold performance value.

In another aspect, a candidate provisioning system for qualifying skilled candidates for an industry position via a provisioning application of a client device is provided. The candidate provisioning system may include a database configured to store information associated with an interactive challenge component, a memory configured to store non-transitory computer executable instructions, and a processor configured to interface with the memory and the database. In particular, the processor may be configured to execute the non-transitory computer executable instructions to cause the processor to provide, via a provisioning application (app), an interactive challenge component, the interactive challenge component executing on a client device associated with a candidate, the interactive challenge component causing the client device to simulate one or more problems, the problems requiring interaction by the candidate; determine, via the provisioning app, a performance metric for the candidate, the performance metric based on the interaction by the candidate; and provide, via the provisioning app, information associated with the industry position, wherein the performance metric for the candidate exceeded a threshold performance value.

### BRIEF DESCRIPTION OF THE DRAWINGS

FIG. 1 illustrates an exemplary computer system for qualifying skilled candidates for an industry position, in accordance with some embodiments.

FIGS. 2A-2F illustrate exemplary user interfaces associated with example notifications and visualizations, in accordance with some embodiments.

FIG. 3 illustrates a flow diagram of an exemplary computer-implemented method for qualifying skilled candidates for an industry position, in accordance with some embodiments.

### DETAILED DESCRIPTION

As discussed above, in some instances, it may be difficult to determine the skill level of a candidate for a position or program using traditional recruiting tools. In particular, for candidates who have short work histories or no work history at all (such as students, or recent graduates), it may be difficult to distinguish the skill level of one candidate from another. Moreover, it may be difficult to reach all potential candidates for a program or a position using traditional job postings alone.

The present application addresses these known problems in the art by providing an interactive challenge component configured to identify skilled candidates for an opportunity in a particular field or industry. The challenge may include simulated problems typical of the field or industry to be solved by participants in the challenge. Accordingly, participants who are able to solve the simulated problems correctly are likely skilled in the field or industry. Potential participants may be given a participation code or other link to complete the challenge electronically and compete against other participants, e.g., over a set period of time. The skill level of each participant may be evaluated and compared over the course of the challenge, and top-scoring participants may be identified as candidates for the opportunity. Advantageously, a large number of participants having an interest in the industry or field may be evaluated at once. Moreover, the competitive aspect of the challenge may provide a more fun and engaging way for participants to be evaluated, compared to traditional recruiting methods.

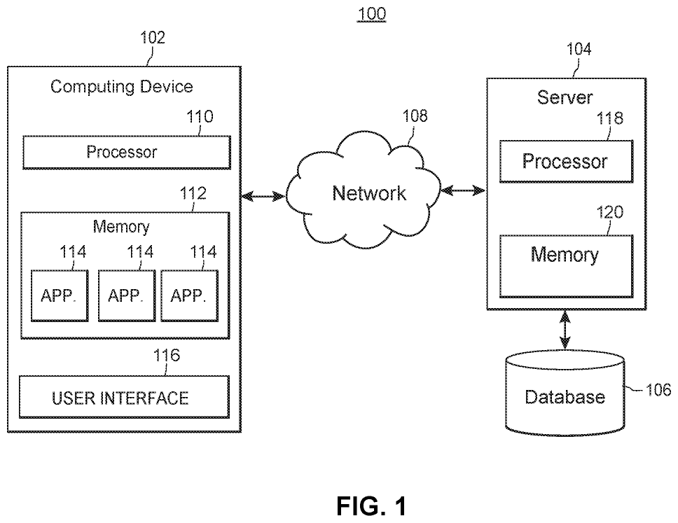

Turning to FIG. 1, an exemplary computer system 100 for qualifying skilled candidates for an industry position is illustrated. The high-level architecture illustrated in FIG. 1 may include both hardware and software applications, as well as various data communications channels for communicating data between the various hardware and software components, as is described below. The system 100 may include a computing device 102, a server 104, and a database 106, which may communicate using one or more network 108, which may be a wireless network, or which may include a combination of wireless and wired networks.

The computing device 102 may in some instances be a collection of multiple co-located or geographically distributed computing devices, etc. Additionally, although only one computing device 102 is shown in FIG. 1, there may be many computing devices 102 (for instance, a computing device 102 for each participant in the interactive challenge component). Each computing device 102 may include a processor 110 and a memory 112. The processor 110 may in some embodiments include multiple processors, and may be configured to execute any of the various software applications 114 residing on the memory 112. Moreover, the memory 112 may include multiple memories, which may be implemented as semiconductor memories, magnetically readable memories, optically readable memories, biologically readable memories, and/or any other suitable type(s) of non-transitory, computer-readable storage media.

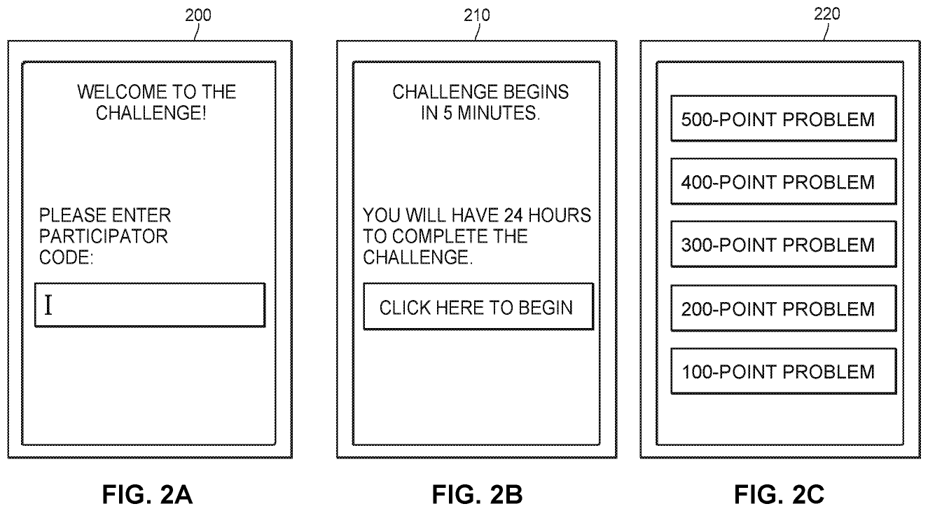

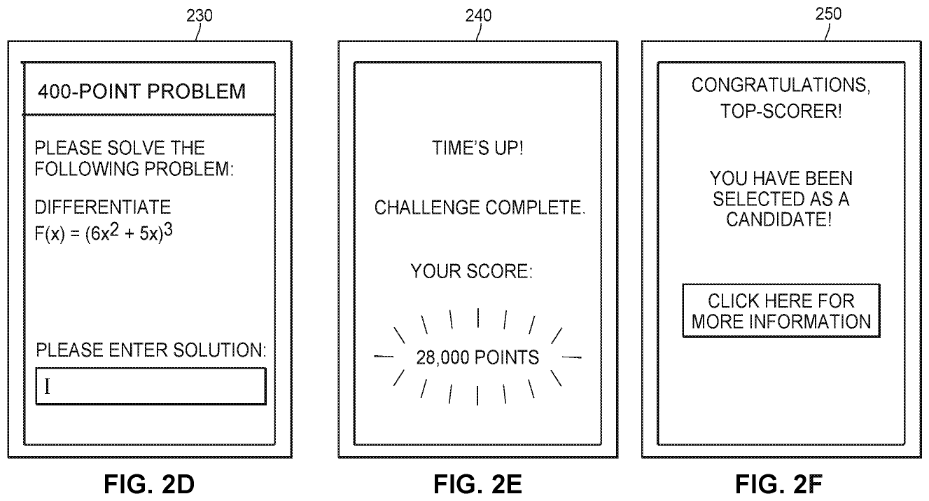

Additionally, the computing device 102 may include a user interface 116 (i.e., a display configured to display a user interface), described in greater detail with respect to FIGS. 2A-2F below. The user interface 116 may be configured to display an interactive challenge component related to the particular industry to a user who participates in the challenge. For instance, the user interface 116 may display simulated problems to be solved by participants in the challenge, and may accept user input corresponding to answers to the problems. Moreover, for candidates identified for the industry opportunity based on their performance in the challenge, the user interface 116 may provide information associated with the industry opportunity.

The server 104 may in some instances be a collection of multiple co-located or geographically distributed servers, etc., and may include a processor 118 and a memory 120. The processor 118 may in some embodiments include multiple processors, and may be configured to execute software applications (not shown) residing on the memory 120. Moreover, the memory 120 may include multiple memories, which may be implemented as semiconductor memories, magnetically readable memories, optically readable memories, biologically readable memories, and/or any other suitable type(s) of non-transitory, computer-readable storage media.

The database 106 may store data related to, inter alia, identifying skilled candidates for an opportunity in a particular industry, simulated problems related to the industry, point values for each simulated problem, threshold score requirements for candidates, timing requirements for an interactive challenge component, various information about the candidates, etc. Accordingly, the computing device 102 and/or the server 104 may access the database 106 via the network 108, and the data stored by the database 106 may be used in the one or more applications 114 or in any applications (not shown) of the memory 120.

The application(s) 114 may include multiple applications and/or may include multiple modules within one or more applications for qualifying skilled candidates for an industry position, e.g., an application (or module) providing an interactive challenge component related to a particular industry to participants, an application (or module) for identifying potential participants in the interactive challenge component, an application (or module) for verifying and/or identifying participants approved to participate in the interactive challenge component, an application (or module) for timing the interactive challenge component, an application (or module) for evaluating each participant (or participant team)'s performance in the interactive challenge component, an application (or module) for identifying one or more of the interactive challenge component participants as candidates for an opportunity related to the particular industry, an application (or module) for providing information associated with the opportunity to the identified candidates, an application (or module) for displaying user interfaces to users, etc. Of course, this is not an exhaustive list of the applications 114 that may be stored in the memory 112, and various embodiments and configurations may include additional, fewer, and/or alternative applications, or some combination of the applications described above.

FIGS. 2A-2F illustrate exemplary user interfaces 200, 210, 220, 230, 240 and 250, associated with example notifications and visualizations related to the interactive challenge component. An electronic device (e.g., computing device 102) may be configured to display the interfaces (e.g., at user interface 116) and/or receive selections and inputs via the interfaces. For example, a dedicated application (e.g., one of the applications 114) that is configured to operate on the electronic device may display the interfaces. It should be appreciated that the interfaces are merely examples and that alternative or additional content is envisioned.

FIG. 2A depicts an exemplary user interface 200 including a prompt to enter a participator code for joining the interactive challenge component. For instance, when potential participants (e.g., students from a particular university or students studying a certain subject) are identified prior to participating in the challenge, these potential participants may be given a participation code to be entered at user interface 200. Additionally, the participation code may include an identifier of the participant for scorekeeping purposes. Additionally or alternatively, a participant may be prompted to enter other identifying information. Of course, in some instances, no participation code may be required.

FIG. 2B depicts an exemplary user interface 210 including an indication of a time limit to complete the interactive challenge component and a start button. For instance, as shown in user interface 210, the challenge will last twenty-four hours and will begin in five minutes. Of course, the interactive challenge component may last any amount of time in various embodiments. Moreover, in some instances, the challenge may not be timed.

FIG. 2C depicts an exemplary user interface 220 displaying point values associated with various problems to be solved in the interactive challenge component. Using the user interface 220, a participant may select the point value of a problem to solve. The point value may be related to, e.g., the difficulty of the associated problem, or an estimated length of time required to complete the problem. Of course, although user interface 220 includes a five-hundred point problem, a four-hundred point problem, a three-hundred point problem, a two-hundred point problem, and a one-hundred point problem (i.e., problems associated with point values in one-hundred point increments), problems may have any incremental point values. Moreover, in some instances, problems may all be equally weighted. Additionally, in some instances, the problems may additionally be sorted and selectable by categories as well as by point value.

FIG. 2D depicts an exemplary user interface 230 displaying a problem to be solved by a participant in the course of the interactive challenge component. As shown in user interface 230, the user has selected a four-hundred point problem in this instance. While a math problem is shown in user interface 230, the problem to be solved may be any type of problem related to the industry or field of the challenge. Additionally, the exemplary user interface 230 includes an area for a participant to enter a solution for the problem. While user interface 230 depicts an area for a participant to enter a text/numerical solution, in some instances the user may be provided with, e.g., multiple choices to select by choosing a button.

FIG. 2E depicts an exemplary user interface 240 displaying a notification indicating that the time limit for the interactive challenge component has been reached, and additionally displaying a notification of the participant's final score on the challenge.

FIG. 2F depicts an exemplary user interface 250 displaying a notification indicating that the participant has been selected as a candidate for an opportunity in the field or industry of the interactive challenge component. The exemplary user interface 250 additionally includes a button that the participant may select to learn more information. The information may include, for instance, information about a position or program related to the field or industry. Additionally, the information may include information about possible interview dates and/or times for a position or program related to the field or industry. Of course, the user interfaces of FIGS. 2A-2F are exemplary user interfaces, and various embodiments may include additional or alternative user interfaces.

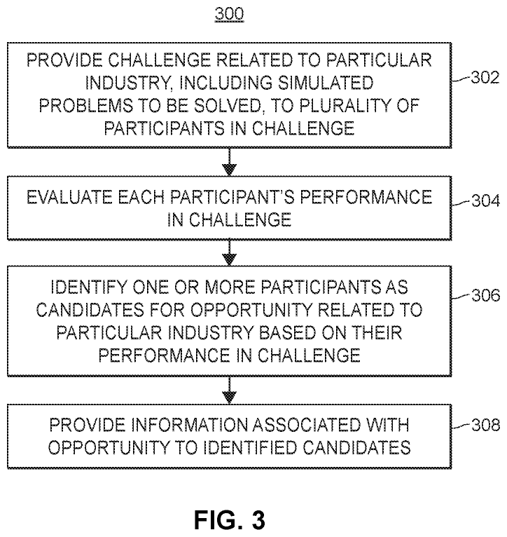

Turning now to FIG. 3, a flow diagram of an exemplary computer-implemented method 300 for qualifying skilled candidates for an industry position is depicted. The method 300 may be implemented by a computer system, such as, e.g., the computer system depicted in FIG. 1.

In the method 300, an interactive challenge component related to a particular industry may be provided to a plurality of participants in the challenge (block 302). The interactive challenge component may include simulated problems to be solved by the participants. In some examples, potential participants may be identified prior to providing the interactive challenge component. For instance, students from a particular university (e.g., a university in a location associated with the opportunity, or a location associated with the industry), or students studying a certain subject (e.g., a subject related to the industry) may be identified as potential participants prior to providing the interactive challenge component, and may be provided with a link or passcode for accessing and/or participating in the challenge. As another example, participants may be identified in other ways—for instance, a link or passcode for accessing and/or participating in the challenge may be available on a website related to the industry, or related to the opportunity. In other examples, participation in the interactive challenge component may be open to any interested participants. In some instances, the participants may participate in the challenge individually, while in other instances, the participants may participate in the interactive challenge component in participant teams.

Generally speaking, the simulated problems to be solved by the participants (or participant teams) may be representative of real problems typically solved in the industry. For example, if the challenge is related to engineering, the simulated problems may be problems that typical engineers must frequently solve. In some instances, the simulated problems may be drafted by individuals in the industry.

In some examples, each simulated problem may be configured to have a single correct solution (e.g., a number, or a multiple choice answer). Additionally, in some examples, each simulated problem may be associated with a point value. For instance, the point value may be related to the difficulty of the problem, e.g., a harder problem may be worth more points than an easier problem. As another example, the point value of a problem may be related to the amount of time needed to solve the problem, e.g., a longer problem may be worth more points than a shorter problem.

In some instances, the interactive challenge component may be a timed challenge (i.e., a challenge with a limited amount of time provided for completing the challenge, such as one hour, twenty-four hours, one week, etc.). Moreover, the interactive challenge component may be configured so that participants (or participant teams) may select which problems to solve and/or which order in which to solve the problems. For example, the timed challenge may be configured so that not all problems will be solved during the time period, requiring participants to strategically select which problems to solve in which order.

Each participant's (or each participant team's) performance in the interactive challenge component may be evaluated (block 304). For instance, in examples where each problem has a single correct solution, the participant's performance may be evaluated based on the number of problems solved correctly. For example, in instances where each simulated problem is associated with a point value, the participant's performance may be evaluated based on the number of points scored by the participant. In a timed challenge, participants may be additionally be evaluated based on their strategic choices in selecting which problems to solve and/or which order in which to solve the problems. Alternatively, in a challenge without a time limit, participants may be evaluated based on the speed in which they solve a given number of problems.

One or more participants (or participant teams) may be identified as candidates for an opportunity related to the particular industry (block 306), based on their performance in the interactive challenge component. For example, in some instances, each participant scoring a certain threshold number of points and/or solving a certain threshold number of problems correctly, may be identified as a candidate. In some instances, a threshold number of high performing participants may be identified as candidates (e.g., the top performing participant, the top ten performing participants, etc.).

In some instances, the opportunity may be a career opportunity, such as a position or internship in the industry. In other instances, the opportunity may be an educational opportunity, such as admission into a particular program related to the industry, or consideration for a scholarship related to the industry. In some instances, the number of participants identified as candidates may be related to the need for opportunity candidates (e.g., the number of available positions, or the number of available spots in a class, etc.)

The identified candidates may be provided with information associated with the opportunity (block 308). For example, when the opportunity is a career opportunity, the information may be information about how to apply for the career opportunity. In some instances, the candidate may be pre-approved for an interview for the career opportunity, and the information may include possible times for the interview. In still other instances, the candidate may be pre-approved for a position at a company in the industry, and the information may include start dates and/or benefit information related to the position. Similarly, when the opportunity is an educational opportunity, the information may be information about how to apply to a program or scholarship related to the industry. In some instances, the candidate may be admitted into a program or may receive a scholarship, and in those instances the information may indicate the admission into the program and/or the scholarship received. In some embodiments, the identified candidates may additionally be awarded with a prize or status associated with their performance in the interactive challenge component.

Although the foregoing text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within an office environment, or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

1. A candidate provisioning method for qualifying skilled candidates for an industry position, the candidate provisioning method executing on one or more processors, the candidate provisioning method comprising:
identifying, via a provisioning application (app), a plurality of potential candidates to participate in an interactive challenge based on criteria including at least one of educational or location criteria;
providing, via the provisioning app, passcodes for accessing or participating in the interactive challenge to each potential candidate of the identified plurality of potential candidates;
receiving, via the provisioning app, passcodes for accessing or participating in the interactive challenge from each of a plurality of geographically distributed client devices, with each passcode and client device associated with a geographically distributed candidate of a plurality of geographically distributed teams of candidates, each candidate of the plurality of geographically distributed teams of candidates being one of the plurality of potential candidates;
verifying, via the provisioning app, the passcodes for accessing or participating in the interactive challenge from each of the plurality of geographically distributed client devices;
providing, via the provisioning app, responsive to verifying the passcodes from each of the plurality of geographically distributed client devices, an interactive challenge component for display via each of the plurality of geographically distributed client devices simultaneously over a time-limited period, the interactive challenge component executing, over the time-limited period, on the plurality of geographically distributed client devices associated with each of the plurality of geographically distributed teams of candidates, the interactive challenge component causing each of the client devices to simulate one or more problems over the time-limited period, the problems requiring interaction by each of the teams of candidates over the time-limited period;
determining, and updating, via the provisioning app, a performance metric for each of the teams of candidates over the time-limited period, the performance metric for each team of candidates being based on the interaction by the team of candidates over the time-limited period; and
providing, via the provisioning app to the client device, information associated with the industry position to teams of candidates associated with performance metrics exceeding a threshold performance value.

2. The candidate provisioning method of claim 1, further comprising:
identifying, via the provisioning app, prior to providing the interactive challenge component to the candidate, one or more potential candidates for the interactive challenge component.

3. The candidate provisioning method of claim 1, wherein each of the simulated problems is associated with a single correct solution, and wherein determining the candidate's performance metric further comprises:
determining, via the provisioning app, whether the team of candidates has identified the single correct solution associated with each simulated problem.

4. The candidate provisioning method of claim 1, wherein each of the one or more simulated problems is associated with a point value, and wherein determining the candidate's performance metric further comprises:
calculating, via the provisioning app, a total point value scored by the team of candidates in the interactive challenge component.

5. The candidate provisioning method of claim 4, wherein providing information associated with the industry position further comprises determining that the performance metric for the team of candidates exceeded a threshold performance value by determining, via the provisioning app, that the team of candidates has scored a point value above a threshold point value in the interactive challenge component.

6. The candidate provisioning method of claim 4, wherein providing information associated with the industry position further comprises determining that the performance metric for the team of candidates exceeded a threshold performance value by determining, via the provisioning app, that the team of candidates is one of a threshold number of teams of candidates scoring the highest point values in the interactive challenge component.

7. The candidate provisioning method of claim 1, wherein the industry position is a career opportunity in the industry.

8. The candidate provisioning method of claim 7, wherein the information associated with the industry position includes information related to an application or to an interview for the career opportunity in the industry.

9. The candidate provisioning method of claim 1, wherein the industry position is an educational opportunity in the industry.

10. The candidate provisioning method of claim 9, wherein the information associated with the industry position includes information related to an application or to a scholarship for the educational opportunity in the industry.

11. A candidate provisioning system for qualifying skilled candidates for an industry position via a provisioning application of a plurality of geographically distributed client devices, comprising:
a database configured to store information associated with an interactive challenge component;
a memory configured to store non-transitory computer executable instructions; and
a processor configured to interface with the memory and the database, and configured to execute the non-transitory computer executable instructions to cause the processor to:
identify, via a provisioning application (app), a plurality of potential candidates to participate in an interactive challenge based on criteria including at least one of educational or location criteria;
provide, via the provisioning app, passcodes for accessing or participating in the interactive challenge to each potential candidate of the identified plurality of potential candidates;
receive, via the provisioning app, passcodes for accessing or participating in the interactive challenge from each of a plurality of geographically distributed client devices, with each passcode and client device associated with a geographically distributed candidate of a plurality of geographically distributed teams of candidates, each candidate of the plurality of geographically distributed teams of candidates being one of the plurality of potential candidates;
verify, via the provisioning app, the passcodes for accessing or participating in the interactive challenge from each of the plurality of geographically distributed client devices;
provide, via the provisioning app, an interactive challenge component for display via each of the plurality of geographically distributed client devices simultaneously over a time-limited period, the interactive challenge component executing, over the time-limited period, on a plurality of geographically distributed client devices associated with each of the plurality of geographically distributed teams of candidates, the interactive challenge component causing each of the client devices to simulate one or more problems over the time-limited period, the problems requiring interaction by each of the teams of candidates over the time-limited period;
determine and update, via the provisioning app, a performance metric for each of the teams of candidates over the time-limited period, the performance metric for each team of candidates being based on the interaction by the team of candidates over the time-limited period; and
provide, via the provisioning app, information associated with the industry position, to teams of candidates associated with performance metrics exceeding a threshold performance value.

12. The candidate provisioning system of claim 11, wherein the non-transitory computer executable instructions further cause the processor to:
identify, via the provisioning app, prior to providing the interactive challenge component to the candidate, one or more potential candidates for the interactive challenge component.

13. The candidate provisioning system of claim 11, wherein each of the simulated problems is associated with a single correct solution, and wherein the non-transitory computer executable instructions causing the processor to determine a performance metric for the team of candidates based on the interaction by the team of candidates further comprise non-transitory computer executable instructions causing the processor to determine, via the provisioning app, whether the team of candidates has identified the single correct solution associated with each simulated problem.

14. The candidate provisioning system of claim 11, wherein each of the one or more simulated problems is associated with a point value, and wherein the non-transitory computer executable instructions that cause the processor to determine a performance metric for the team of candidates based on the interaction by the team of candidates further include instructions that cause the processor to calculate, via the provisioning app, a total point value scored by the team of candidates in the interactive challenge component.

15. The candidate provisioning system of claim 14, wherein each of the one or more simulated problems is associated with a point value, and wherein the non-transitory computer executable instructions that cause the processor to provide information associated with the industry position further include instructions that cause the processor to determine that the team of candidates has scored a point value above a threshold point value in the interactive challenge component.

16. The computer system of claim 14, wherein each of the one or more simulated problems is associated with a point value, and wherein the non-transitory computer executable instructions that cause the processor to provide information associated with the industry position further include instructions that cause the processor to determine, via the provisioning app, that the team of candidates is one of a threshold number of teams of candidates scoring the highest point values in the interactive challenge component.

17. The candidate provisioning system of claim 11, wherein the industry position is a career opportunity in the industry.

18. The computer system of claim 17, wherein the information associated with the industry position includes information related to an application or to an interview for the career opportunity in the industry.

19. The candidate provisioning system of claim 11, wherein the industry position is an educational opportunity in the industry.

20. The candidate provisioning system of claim 19, wherein the information associated with the industry position includes information related to an application or to a scholarship for the educational opportunity in the industry.
